(19) United States
(12) Patent Application Publication
(10) Pub. No.: US 2002/0069122 A1
(43) Pub. Date: Jun. 6, 2002

(54) Method and system for maximizing credit card purchasing power and minimizing interest costs over the internet

(76) Inventors: Insun Yun, Long Island City, NY (US); Casey Ilsun Kim, Palisades Park, NJ (US); Augustin Mateescu, Long Island City, NY (US); Arthur L. Bergman, Hackensack, NJ (US); Wah Im, Flushing, NY (US); Jinhyong Seo, Port Washington, NY (US); Yongjin Chang, Manhasset, NY (US)

Correspondence Address: SCULLY, SCOTT, MURPHY & PRESSER, 400 Garden City Plaza, Garden City, NY, 11530, US

(21) Appl. No.: 09/789,466

(22) Filed: Feb. 21, 2001

Related U.S. Application Data
(60) Provisional application No. 60/183,998, filed on Feb. 22, 2000.

(51) Int. Cl. G06F 17/60

(52) U.S. Cl. 705/26

(57) ABSTRACT

According the present invention, there is provided a method and system for facilitating an electronic commerce (e-commerce) transaction by a consumer, the method comprising: acquiring a purchase amount for an e-commerce transaction between a consumer and an Internet shopping portal; querying each of a plurality of consumer accounts for associated financial information; evaluating said associated financial information obtained for each of the plurality of consumer accounts; and facilitating a selection of one or more accounts based on the evaluation step to enable the consumer to complete the e-commerce transaction.

### CROSS-REFERENCE TO RELATED APPLICATIONS

This application claims the benefit of U.S. Provisional Patent Application Serial No. 60/183,998, which was filed Feb. 22, 2000 and entitled “METHOD AND SYSTEM FOR MAXIMIZING CREDIT CARD PURCHASING POWER AND MINIMIZING INTEREST COSTS OVER THE INTERNET,” and the subject matter of which is hereby incorporated by reference.

### BACKGROUND OF THE INVENTION

1. Technical Field of the Invention

The present invention relates generally to electronic commerce (i.e., e-commerce), and relates more particularly to a method and system for facilitating a consumer to make efficient, economical and advantageous purchasing decisions for e-commerce transactions utilizing the consumer's financial portfolio, as well enabling efficient bill payment decisions for a plurality of consumer's credit card and consumer credit accounts.

2. Description of the Related Art

In the past decade electronic commerce (e-commerce) has grown at an impressive rate. As e-commerce becomes a predominant source of revenue in the business market, it is essential to make transactions over the Internet secure, effective and economical for the consumer. There are currently few payment systems available for use over the Internet. One of the most effective vehicles for payment of purchases over the Internet has been the conventional credit card, exemplified by MasterCard™, Visa™, American Express™, Discover™, and the like.

A typical credit card purchase over the Internet involves four main parties: a consumer (credit card holder); a merchant which offers products or services for sale; a merchant bank that has contracted with the merchant to enable the merchant to accept credit card payments over the Internet; and a credit card processor that processes credit card payments for the merchant bank, generally through a financial network on behalf of a plurality of merchant banks.

The following generally describes a credit card transaction by a consumer, which takes place over the Internet. Initially, the consumer accesses the Internet via an Internet Service Provider (ISP) and a personal computer running an HTML browser program such as Netscape Navigator™, Internet Explorer™ (IE) or America Online™ (AOL). The consumer may then access any one of a multiplicity of e-commerce shopping portals, which are established by merchants for shopping over the Internet.

Shopping portal may include Internet-based merchants as well as conventional “brick-and-mortar” merchants that sell their products via the Internet. Well known shopping portals include: Amazon.com™, Sony.com™, Dell.com™, and the like.

When the consumer decides to purchase something of interest at a particular shopping portal, a merchant e-commerce application shifts to a secure Web server that provides for encrypted communication and prompts the consumer for credit card information, usually along with other identification information such as the consumer's residence address and a shipping address. Some e-commerce sites offer virtual “shopping carts” into which the consumer may “store” items of interest to be subsequently purchased. After all items of interest have been selected, the consumer is given the opportunity to review the shopping cart entries and make any corrections necessary before checkout. At some shopping portals, shopping is done on an unsecured server, with the shift to a secure server occurring when the consumer is ready for checkout and payment. After the consumer has selected items for purchase but before purchase of the items, the consumer enters the desired consumer identification, including the consumer's address and the desired shipping address, and then the desired payment information (e.g., most frequently credit card information) into a form, which is conventionally encrypted and electronically transmitted to a merchant's Web server. The form may be encrypted and electronically transmitted to the merchant's Web server utilizing Secure Sockets Layer (“SSL”), which is an effective and secure technique for transmitting sensitive information (e.g., credit card information) over the Internet.

Invariably, Internet-based merchants implement payment software enabled to process real-time payment authorizations. Therefore, using the payment software incorporated in the foregoing merchant's Web server, the merchant transmits a similarly encrypted transaction to a credit card processor to obtain an authorization for the transaction. The authorization is a request to hold funds for the purchase. The credit card processor either authorizes a certain amount of money by issuing an authorization code, or declines the transaction. The issuance of an authorization code by the processor reduces the consumer's available credit for the credit card used for the purchase, but does not actually put a charge (i.e., a debit) on the consumer's bill or move money to the merchant. Rather, the merchant implements a capture process once the transaction is authorized, which takes the information from the successful authorization and charges the authorized amount of money to the consumer's credit card.

To facilitate e-commerce, Internet sites require the capability to accept payments electronically. As aforementioned, credit card payments have been the predominant medium of payments over the Internet. The process of shopping via the Internet is similar to a process of purchasing a product via a telephone from a catalogue and paying via a credit card. In shopping on the Internet, purchasers browse online catalogues, select products for purchase, fill in their credit card information and address information on a Web page and send the information to a merchant via the Internet. A significant difference between the two shopping methods is how highly sensitive information (e.g., credit card information) is transmitted to the merchant. By using the telephone, purchasers verbally communicate via a private telephone connection, which is generally considered secure. However, because of the public nature of the Internet, the information that is transmitted via the Internet is inherently unsecured. Once the sensitive information is packetized (i.e., in data packet form) and transmitted outside the personal computer, it is directed by a plurality of intermediate computers (e.g., routers), which facilitate delivery of the information to an intended destination. Thus, the information is subject to prey and interception at almost every point along its route to the intended destination. Therefore, security concerns predominate e-commerce transactions between consumers (i.e., cardholders) and merchants.

There are two primary Internet protocols for securing purchases over the Internet. As aforementioned, the first protocol is SSL. SSL is currently the Internet standard, which addresses the security of a transaction between the consumer (e.g., cardholder) and the merchant by creating a secure session via strong public key encryption technology that scrambles the transaction information. When information arrives at its destination (e.g., merchant), it is decrypted and is readable in its normal format. A key concern with the SSL protocol is that SSL provides no authentication of the merchant or the consumer in the transaction. A second protocol is a Secure Electronic Transactions protocol (“SET”). Visa International and MasterCard have jointly developed this protocol in 1996 and it overcomes the key issue not addressed by SSL; namely authentication. The SET protocol provides confidentiality of order and payment information, authenticates the consumer cardholder and merchant. The SET protocol further has strong encryption, incorporating public key cryptology from RSA Data security.

With the advent and proliferation of the Internet, bill paying has been transformed from a tedious time-consuming pen-to-check and mail method, to an easy timesaving Web-based click-to-pay experience. There are currently several Web-based services, which allow a consumer to pay all of the consumer's bills online with a click of a button, exemplified by PayMyBills.com™, PayTrust.com™ and StatusFactory.com™. A number of banks also offer electronic bill payment as part of their electronic banking programs. A consumer preferring to pay his or her bills automatically, initially needs to accesses the Internet via an Internet Service Provider (ISP) and a personal computer running an HTML browser program as described hereinabove. The consumer may then access any one of many Internet-based bill-paying services, including those mentioned hereinabove, by typing in a Universal Resource Locator (“URL”) for the particular bill-paying service the on the Web browser.

At a typical bill payment service Web site, the consumer signs up to receive service over the Internet and receives a password. Thereafter, by fax or conventional mail, the consumer submits a voided check from the consumer's checking account to arrange for electronic payments, which are known as direct debit. The consumer or the service on behalf of the consumer, next redirects a plurality of consumer's bills to the service, by asking that the address of each of the plurality of consumer's bills be modified to that of the service. Each of the plurality of bills may either be a paper or an electronic bill. The service then converts the paper bill to an electronic document (e.g., HTML document, Adobe® Acrobat document, or the like) to facilitate it's display to the consumer over the Internet through an HTML Web browser, utilizing available plugins for non-HTML electronic documents. Following the conversion, the service notifies the consumer by e-mail that the consumer has a pending bill. Following the e-mail notification, the consumer logs onto the service's Web site by using the password and sets up payment. The consumer may elect to pay a bill automatically for a full amount or for an amount specified by the consumer, or manually on any date the consumer chooses to pay the bill. The service has an overdraft safeguard to prevent the consumer's checking account from being overdrawn for paying the pending bill by notifying the consumer that a deposit of funds into the checking account is necessary. The service will also automatically combine bill payment information for the plurality of consumer's bills with the consumer's checking account balance, enabling the consumer to monitor the balance on the consumer's checking account.

Most e-commerce web sites provide for payments via a consumer-provided and consumer-selected credit card, debit card or check that is provided over the Internet, or via an alternate medium such as a telephone. Invariably, the consumer selects and provides a credit card for an electronic purchase, one that the consumer thinks has enough available credit to cover a purchase amount and one that the consumer thinks has the lowest interest rate.

Most credit card issuers provide one or more interest rates applicable to the consumers existing credit card balance. In some cases, involving transferred funds, there may be three separate interest rates being charged: A first rate for the transfer balance, a second rate for purchases made during the immediately preceding 30 days, and a third rate on the remaining balance. Penalty charges for late payments are also common. Late payments may also trigger conversion of a preferred rate on a transferred balance into a higher rate, which may substantially penalize the consumer.

U.S. Pat. No. 6,006,205 describes a credit card billing method and system that permits multiple items purchased as part of a single transaction to be separately billed on a credit card, which is designed to minimize inquiries regarding the overall order by the consumer.

U.S. Pat. No. 5,991,738 describes an automated payment system that is suited for purchases over the Internet, wherein a consumer may gain full access to a merchant web site restricted by a password by providing a credit card payment and receiving a password.

U.S. Pat. No. 5,727,249 describes an automated payment system and method for collecting payments using an automated draft printing system operated by a payment collector via a telephone, wherein funds may be collected from a consumer's checking account when authorized, without requiring that an executed check be mailed to a payee.

U.S. Pat. No. 5,914,472 describes a credit card spending authorization control system and method for allowing a parent to control the use of an ancillary credit or debit transaction card which is issued to a child, wherein the parent may set a spending limit for the ancillary card and be contacted for authorization or denial of a transaction entered into by the child, which exceeds the set spending limit.

U.S. Pat. No. 5,949,044 describes a financial tender transfer system that allows a transferor to transfer credit or make payment to a transferee by debiting a credit card of the transferor and crediting a credit card of the transferee, wherein a central controller responsive to entered credit card information generates a single-use identifier to facilitate secure tender of funds from the transferor to the transferee.

Based on the foregoing, it is highly desirable to provide a method and system for making e-commerce transactions more efficient, economical and advantageous for the consumer.

Thus, it is highly desirable to provide a method and system to maximize purchasing power available to a consumer by merging available credit balances of a plurality of consumer's major credit card accounts (e.g., described herein above), retail credit card accounts (Macy's™ credit card, and the like), banking accounts providing for electronic transfer (e.g., saving, checking and money market accounts, and the like), and other financial accounts (e.g., brokerage accounts, Western Union™, and the like).

It is further highly desirable to provide a method and system to minimize credit card interest costs for an e-commerce transaction, by automatically recommending a preferred credit card or consumer credit account that may accommodate a purchase amount and one that bears the lowest interest rate.

It is yet further highly desirable to provide a method and system to minimize credit card interest payments by allocating a payment provided by the consumer to a plurality of consumer's credit cards according to an interest minimization algorithm.

### SUMMARY OF THE INVENTION

Therefore, it is an object of the present invention, especially given today's dynamic and rapidly changing e-commerce environment; to provide an Internet-based method and system for displaying a consumer's credit and banking portfolio in real-time, enabling the consumer to know available credit and interest rate for each of consumer's credit card accounts and credit balances in the consumer's bank accounts and financial accounts, so as to enable the consumer to make the most advantageous e-commerce purchasing decisions.

It is a further object of the present invention to provide a method and system for facilitating an e-commerce purchase transaction by a consumer for an amount within a recommended credit card's available balance and at the lowest interest rate of the consumer's plurality of credit card accounts.

It is yet a further object of the present invention to provide a method and system for facilitating e-commerce purchase transaction by a consumer for an amount that is greater than the available credit of any one of a plurality of credit card accounts, banking accounts and financial accounts by merging consumer's available balances in credit card accounts, banking account, financial accounts and the like into a virtual credit account, which is utilized by the consumer to pay for the e-commerce transaction.

It is another object of the present invention to provide a method and system for managing a consumer's bill payments associated with a plurality of credit card accounts, while minimizing interest payments by allocating monthly payments to each of the plurality of consumer's credit cards based on the provided payment, minimum payment and interest rate for each of the plurality of consumer's credit card accounts.

According to an embodiment of the present invention, there is provided a method for facilitating an electronic commerce (e-commerce) transaction by a consumer, the method comprising: acquiring a purchase amount for an e-commerce transaction between a consumer and an Internet shopping portal; querying each of a plurality of consumer accounts for associated financial information; evaluating the associated financial information obtained for each of the plurality of consumer accounts; and facilitating a selection of one or more accounts based on the evaluation step to enable the consumer to complete the e-commerce transaction.

According to another embodiment of the present invention, there is provided a method for facilitating an electronic commerce (e-commerce) transaction by a consumer, the method comprising: acquiring a purchase amount for an e-commerce transaction between a consumer and an Internet shopping portal; querying each of a plurality of consumer accounts for associated financial information; evaluating the associated financial information obtained for each of the plurality of consumer accounts; and recommending an account to the consumer based on the evaluation step to thereby facilitate the consumer to select the account to complete the e-commerce transaction.

According to yet another embodiment of the present invention, there is provided a method for facilitating an electronic commerce (e-commerce) transaction by a consumer, said method comprising: acquiring a purchase amount for an e-commerce transaction between a consumer and an Internet shopping portal; querying each of a plurality of consumer accounts for associated financial information; evaluating the associated financial information obtained for each of the plurality of consumer accounts; creating a virtual account to merge available balances of two or more of the plurality of consumer accounts to enable the consumer to fund the purchase amount; and funding the purchase amount drawn from the two or more consumer accounts to complete the e-commerce transaction.

According to a further embodiment of the present invention, there is provided a system for facilitating electronic commerce (e-commerce) transactions by one or more consumers, the system comprising: a registry website server for registering a plurality of consumer accounts for each consumer and for transmitting financial information associated therewith to an account manager frame at a consumer's computer; a web browser at the consumer's computer for communicating to an e-commerce server to perform an e-commerce transaction for a purchase amount, the transaction being initiated by the consumer at the web browser; the account management frame querying the registry website server to obtain the financial information for each of the plurality of consumer accounts, evaluating the financial information and facilitating the selection of one or more consumer accounts based on the evaluation to enable the consumer to complete said e-commerce transaction.

According to still a further embodiment of the present invention, there is provided a system for facilitating electronic commerce (e-commerce) transactions by one or more consumers, the system comprising: a registry website server for registering a plurality of consumer accounts for each consumer and for transmitting financial information associated therewith to an account manager frame at a consumer's computer, the consumer directing said account management frame to recommend one of consumer's accounts for a purchase price associated with an e-commerce transaction; a web browser at the consumer's computer for communicating to an e-commerce server to perform the e-commerce transaction, the transaction being initiated by the consumer at said web browser; the account management frame querying the registry website server to obtain the financial information for each of the plurality of consumer accounts, evaluating the financial information and recommending a consumer account based on the evaluation to enable the consumer to complete said e-commerce transaction.

According to yet a further embodiment of the present invention, there is provided a system for facilitating electronic commerce (e-commerce) transactions by one or more consumers, the system comprising: a registry website server for registering a plurality of consumer accounts for each consumer and for transmitting financial information associated therewith to an account manager frame at a consumer's computer, the consumer directing said account management frame to merge one or more of consumer's accounts for a purchase price associated with an e-commerce transaction; a web browser at the consumer's computer for communicating to an e-commerce server to perform an e-commerce transaction, the transaction being initiated by the consumer at said web browser; the account management frame acquiring the purchase amount for the e-commerce transaction from the consumer, querying the registry website server to obtain the financial information for each of the plurality of consumer accounts, evaluating the financial information and enabling the consumer to create and fund a virtual account at the registry website by merging available balances of two or more consumer's accounts to enable the consumer to complete the e-commerce transaction.

### BRIEF DESCRIPTION OF THE DRAWINGS

The objects, features and advantages of the present invention will become apparent to one skilled in the art, in view of the following detailed description taken in combination with the attached drawings, in which:

FIG. 1 is an exemplary block diagram that illustrates an electronic commerce (e-commerce) environment for a credit card purchase transaction according to the present invention.

FIG. 2 is an exemplary block diagram that illustrates servers that comprise Registry Website of FIG. 1 according to the present invention.

FIG. 3 is an alternate embodiment of an account management frame for displaying a consumer's credit card and banking portfolio, and for facilitating the consumer to make efficient, economical and advantageous payments for e-commerce transactions according to the present invention.

FIG. 4 is an exemplary Registry Website home page for displaying services offered at the Registry Website and allowing the consumer to register with and login into the Registry Website according to the present invention.

FIG. 5 exemplary embodiment of a logon frame for allowing the consumer to logon to the account management frame according to the present invention.

FIG. 6 is a preferred embodiment of an account management frame for displaying a consumer's credit card account, banking account and other financial account portfolio, and for facilitating the consumer to make efficient, economical and advantageous payments for e-commerce transactions according to the present invention.

FIG. 7 is an exemplary illustration of a shopping portal address entry web page and an auto-fill feature of the account management frame according to the present invention.

FIG. 8 is an exemplary illustration of a drag-and-drop feature of the account management frame for automatically filling in address information on a shopping portal address entry web page according to the present invention.

FIGS. 9 and 10 are exemplary illustrations a recommender feature of the account management frame for recommending a preferred account for an e-commerce transaction according to the present invention.

FIG. 11 and 12 are exemplary illustrations of a shopping portal payment entry web page and a consumer selection of a credit account according to the recommender feature illustrated FIGS. 9 and 10 and automatic fill-in of the credit account information via an auto-fill feature according to the present invention.

FIGS. 13-17 are exemplary illustrations of an e-Merge feature of the account management frame according to the present invention.

FIG. 18 is an exemplary block diagram of a system for making payment to a plurality of consumer's credit card accounts, while minimizing interest payments.

FIG. 19 is an exemplary flowchart for illustrating application of consumer-provided funds used in the payment process illustrated in FIG. 18 according to the present invention.

FIG. 20 is an exemplary web page to facilitate entry of consumer's name and contact information for registration with Registry Website according to the present invention.

FIG. 21 is an exemplary web page to facilitate entry of consumer's credit card and other account information for registration with Registry Website according to the present invention.

### DETAILED DESCRIPTION OF THE PREFERRED EMBODIMENTS OF THE INVENTION

Reference will now be made to a preferred embodiment according to this invention, examples of which are shown in the accompanying drawings. Where applicable, the same reference numbers represent the same or similar elements in the different drawings.

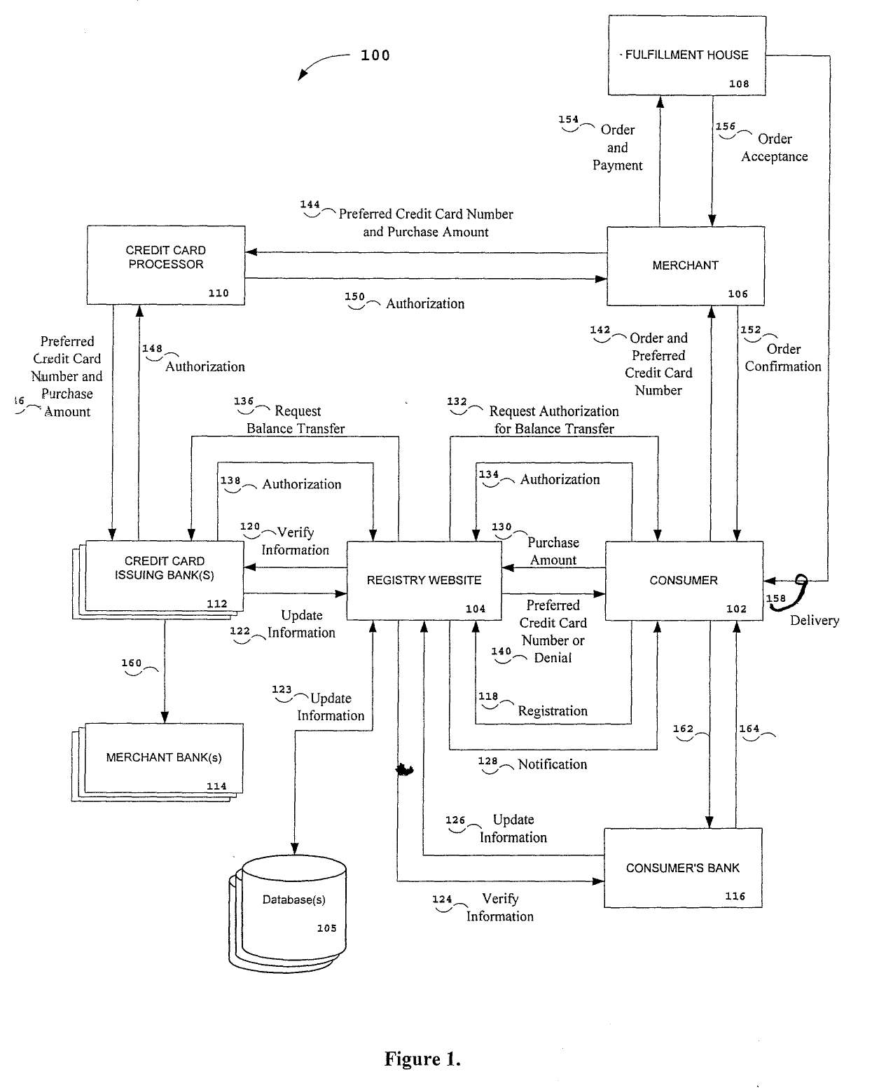

FIG. 1 illustrates and exemplary block diagram of an electronic commerce (e-commerce) environment 100 for a shopping transaction according to the present invention. As aforementioned, there are typically four parties which are involved in an e-commerce transaction: a consumer 102; a merchant 106 that offers products or services for sale over the Internet; a merchant bank 114 that has contracted with the merchant to enable the merchant to accept credit card payments over the Internet; and a credit card processor 110 that processes credit card payments for the merchant bank. Other parties that may also be involved in e-commerce transaction over the Internet include one or more credit card issuing banks 112, a consumer's bank 116, and a fulfillment house 108. These parties will be described herein below with reference to making an e-commerce purchase.

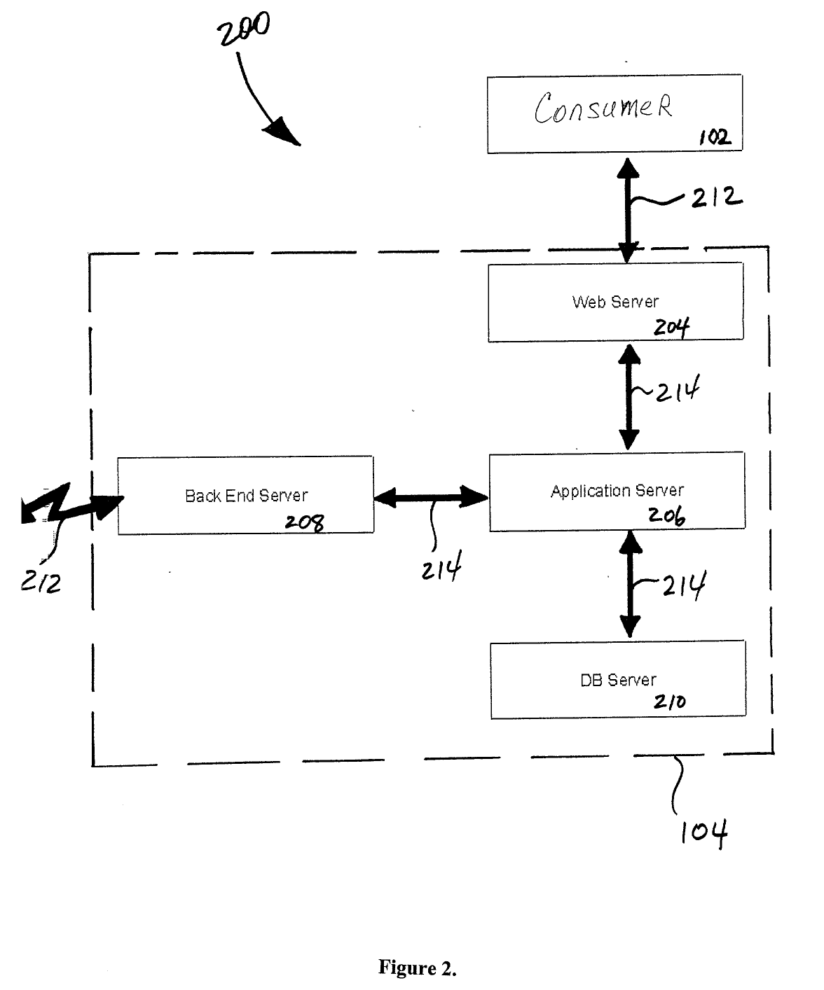

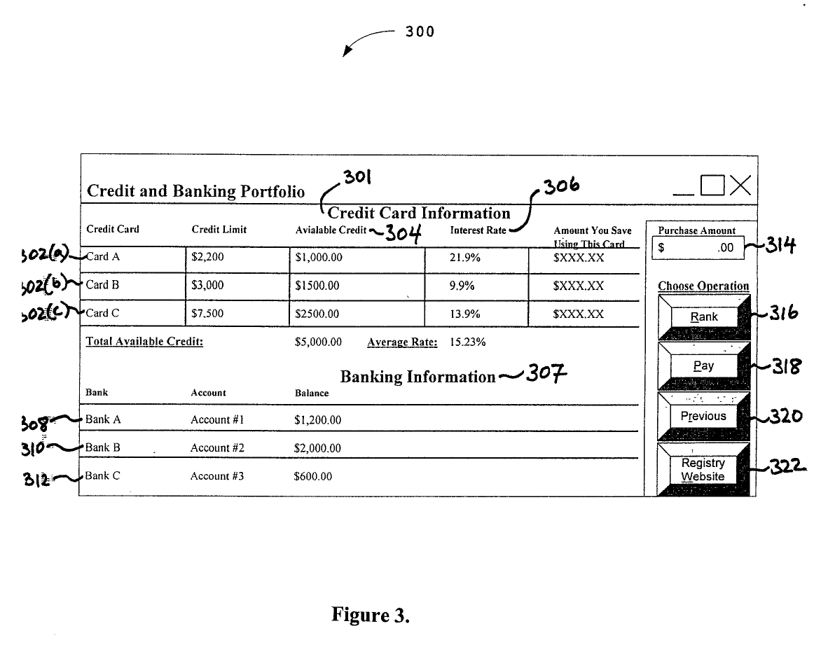

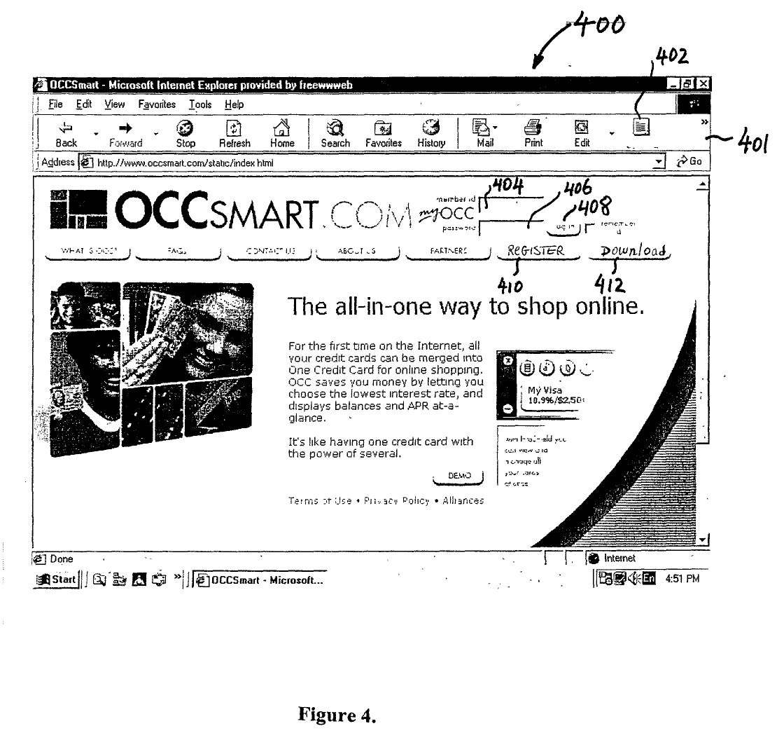

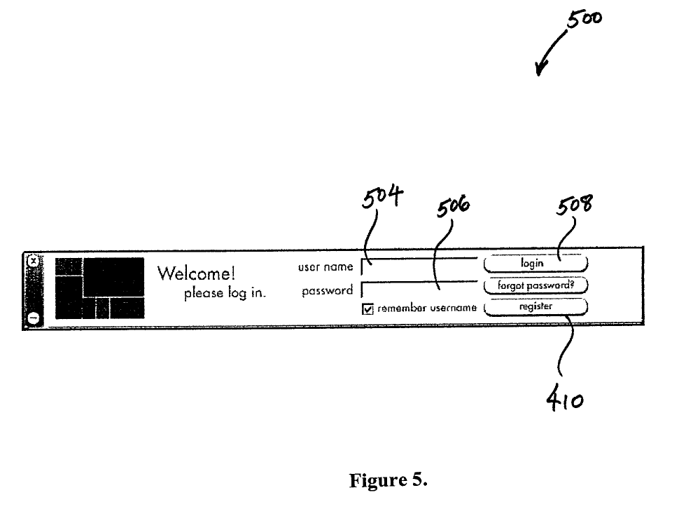

As shown in FIG. 1, a consumer 102 registers at step 118 by providing personal information, information for a plurality of credit card accounts, banking accounts, and other financial information (e.g., accounts from which money may electronically transferred) to the Registry Website 104. At this time, Registry Website 104 preferably queries the consumer 102 to enter a user name and password for all subsequent logins by consumer 102 to the Registry Website 104 and to the account management frame (described herein below with reference to FIG. 4 and 5). It is readily apparent to a skilled artisan that the same username and password are used for the benefit of consumer 102 in that consumer 102 need only remember one username and password. However, separate and distinct username and password may be allocated for logging onto the Registry Website 104 and the account management frame (FIGS. 4 and 5). Now further referring to FIG. 1, Registry Website 104 in turn verifies the foregoing information submitted 120, by polling (e.g., querying) one or more credit card issuing banks 112, consumer's bank 116 and one or more financial institutions for other financial information, all of which provide updated information 122 for the consumer's credit, banking information and other financial information, respectively. Registry Website 104 then updates its one or more databases 105 at step 123 with verified information thus provided. It should be noted that the one or more databases may be IBM DB2™, Oracle™ databases, and the like. Once information has been verified and updated in its one or more databases 105, Registry Website 104 notifies the consumer at step 128 of an approval or denial for an account with Registry Website 104, preferably via e-mail or alternatively via conventional mail. If consumer 102 is approved, Registry Website 104 may also include in the e-mail, the consumer's username and password for all subsequent logins to Registry Website and to the account management frame (FIGS. 4 and 5). It should be noted that Registry Website 104 comprises one or more servers that will be described in greater detail herein below with reference to FIG. 2. It further should be noted, that Registry Website 104 is enabled for communication between it, the one or more credit card issuing banks 112, consumer's bank 116, and other financial institutions (not shown), thus facilitating retrieval of credit card information, banking information, and other financial information and facilitating e-commerce transactions. Further description of FIG. 1 will be made with reference to the alternate embodiment of the account management frame of FIG. 3 herein below.

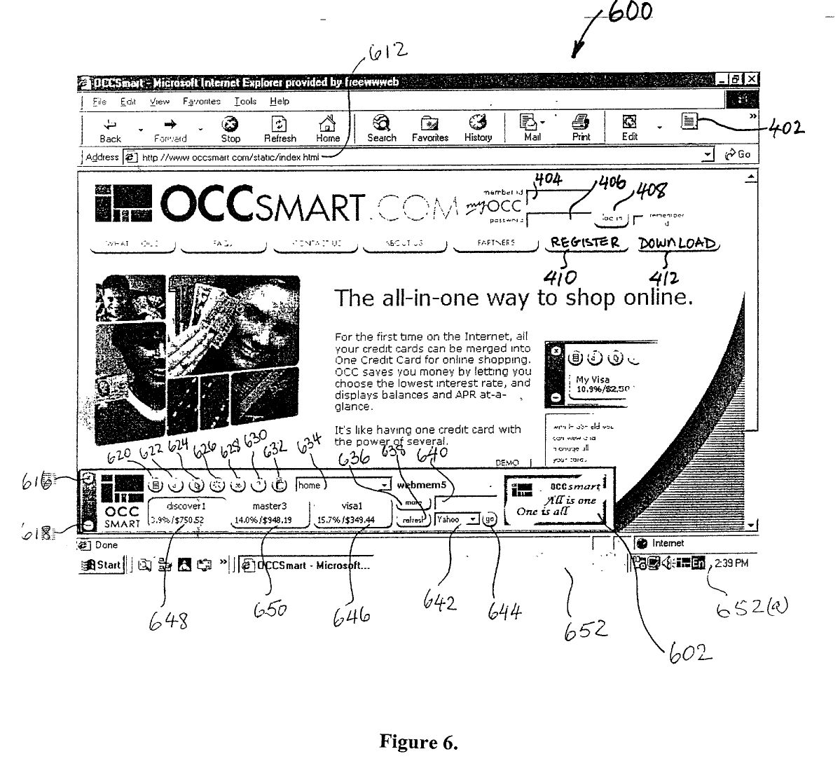

FIG. 2 illustrates an exemplary block diagram 200 of one or more servers comprising Registry Website 104 of FIG. 1 according to the present invention. Consumer 102 may connect to Registry Website 104 via communication network (i.e., Internet). Registry Website 104 preferably comprises Web server 204 that is capable of receiving user requests, transmitting web pages to the consumer's web browser and the account management frame (described herein below with reference FIGS. 3 and 6), and capable of generating Web frames for displaying information to the consumer as well as web forms for capturing consumer-entered data. Registry Website 104 further preferably comprises an application server 206 for handling communications between a consumer 102 (having Internet access and the account management frame) and backend server 208 and DB server 210. Application server 206 is connected via communication network (e.g., Intranet, Internet, LAN, WAN, or the like) 214 to backend server 208, which is interconnected via communication network 212 (e.g., Intranet, Internet, LAN, WAN, or the like) to credit card issuing banks 112, merchant banks 114, consumer's bank 116, credit card processors 110, and the like. DB server 210 is interconnected via communication network (e.g., Intranet, Internet, LAN, WAN, or the like) 214 to application server 206 and stores user's financial information. DB server 210 processes information sent by credit card issuing banks 112, merchant banks 114, consumer's bank 116, credit card processors 110, and the like. DB server 210 further processes requests for information from consumer 102 (via the Internet and account management frame), application server 206 and backend server 208, and distributes information accordingly. It should be noted that additional servers may be provided based on particular design requirements.

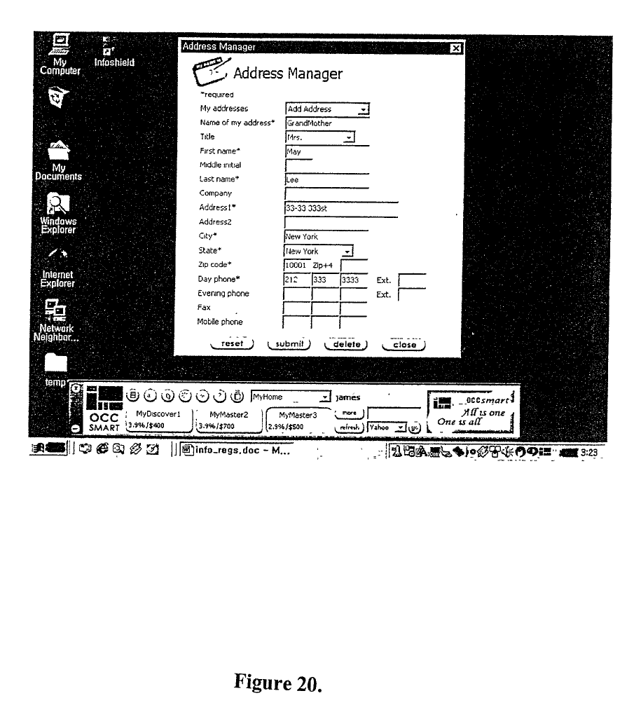

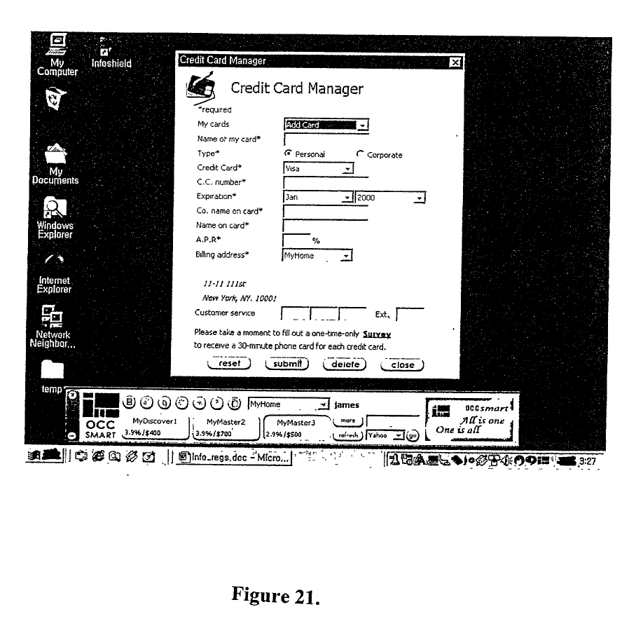

FIG. 4 is a representative example of home page 400 for Registry Website 104 of FIG. 1 that may be displayed to consumer 102 wishing to take advantage of making efficient, economical and advantageous purchasing decisions for e-commerce transactions by registering with Registry Website 104. If consumer 102 has never registered with Registry Website 104, consumer 102 loads home page 400 by typing an associated Uniform Resource Locator (“URL”) for home page 400 of the Registry Website 104. Thus, in order to register, consumer 102 clicks with a pointing device (e.g., mouse) or keyboard on button 410, which directs Registry Website 104 to transmit appropriate one or more registration web pages to consumer's web browser to facilitate entry of consumer's personal information (e.g., consumer name and contact information) as depicted in FIG. 20, financial information (e.g., credit card accounts, banking accounts and other financial accounts) as depicted in FIG. 21, and logon information, such as username and password (not shown) for subsequent logins by consumer 102 to Registry Website 104 and to the account management frame (described herein below with reference to FIG. 4 and 5). Registry Website 104 may allow consumer 102 to use the same username and password both for logging into Registry Website 104 and the account management frame. After providing the foregoing information and being registered, consumer 102 is further queried via download button 412 regarding whether consumer 102 would like to utilize the account management frame for making efficient, economical and advantageous purchasing decisions for e-commerce transactions utilizing the consumer's financial information. It should however be noted that consumer 102 may via download button 412 download the account management frame and install it without first registering with Registry Website 104, and subsequently utilizing register button 410 on logon web frame 500 of FIG. 5 register with, Registry Website 104 in the same manner to obtain an account.

Furthermore with regard FIG. 4, the account management frame may an executable file to be downloaded and installed on consumer's computer, or downloadable Java Applet or ActiveX control that is automatically activated when consumer 102 loads home page 400 via the foregoing URL. Preferably, the account management frame is downloaded to the consumer's computer. Consumer 102 is queried regarding an operating system for which the account management frame is to be downloaded. Registry Website 104 uploads via conventional means (e.g., File Transfer Protocol—“FTP”, or the like), the account management frame to the consumer's computer. Thereafter, installation may be remotely instantiated by Registry Website 104 by automatically executing the executable file, or consumer 102 may conventionally install the account management frame at the consumer's computer. In a Windows™ environment, conventional installation may be performed by using a “run” function and selecting the executable file to install. During installation, icon 402 may be embedded into web browser toolbar 401 for subsequently instantiating logon web frame 500 (described in further detail with reference to FIG. 5) and logging onto the account management frame. It should be noted that a shortcut for instantiating logon web frame 500 may likewise be placed on a Windows™ desktop, Windows™ programs menu, and Windows™ systems tray in a conventional manner. Alternatively, the account management frame is a downloadable Java Applet or ActiveX control. Once consumer 102 has been registered and has received a Registry Website 104 account, the consumer logs on to Registry Website or the account management frame depicted respectively in FIGS. 4 and 5 with the username and password provided. At Registry Website 104, among other things, consumer 102 may optionally select to change personal and financial information, including adding or changing credit card accounts and banking information and other financial information. Furthermore, at Registry Website 104, consumer 102 may select to make bill payments and review bill-payment information and history of payments.

Additionally with regard to FIG. 4, if consumer 102 has previously registered with Registry Website 104, input fields 404 and 406 are respectively provided for inputting username and password information for logon 408 into Registry Website 104, or button 402 is provided to automatically instantiate logon web frame 500 of FIG. 5 for logging onto the account management frame, which is illustrated in a preferred and an alternate embodiment respectively in FIGS. 6 and 3.

FIG. 5 illustrates an exemplary embodiment of a logon web frame 500 for allowing consumer 102 to login onto the account management frame, which is illustrated in a preferred and alternate embodiment respectively in FIGS. 6 and 3. Just like its counterpart home page 400 of FIG. 4, logon web frame 500 of FIG. 5 provides input fields 504 and 506, respectively for username and password and button 508 for logging onto the account management frame (described herein below with reference to FIG. 3 and 6). Furthermore, if consumer 102 has previously downloaded InfoShield but currently remains unregistered with Registry Website 104, register button 410 directs Registry Website 104 to transmit appropriate one or more registration web pages to consumer's web browser for facilitating consumer registration in the same manner as described with reference FIG. 4.

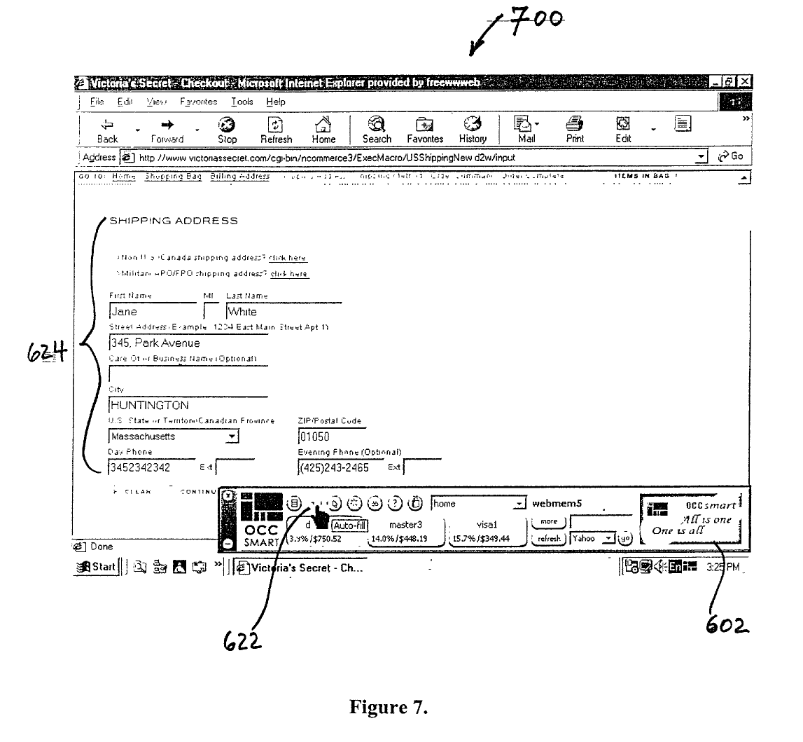

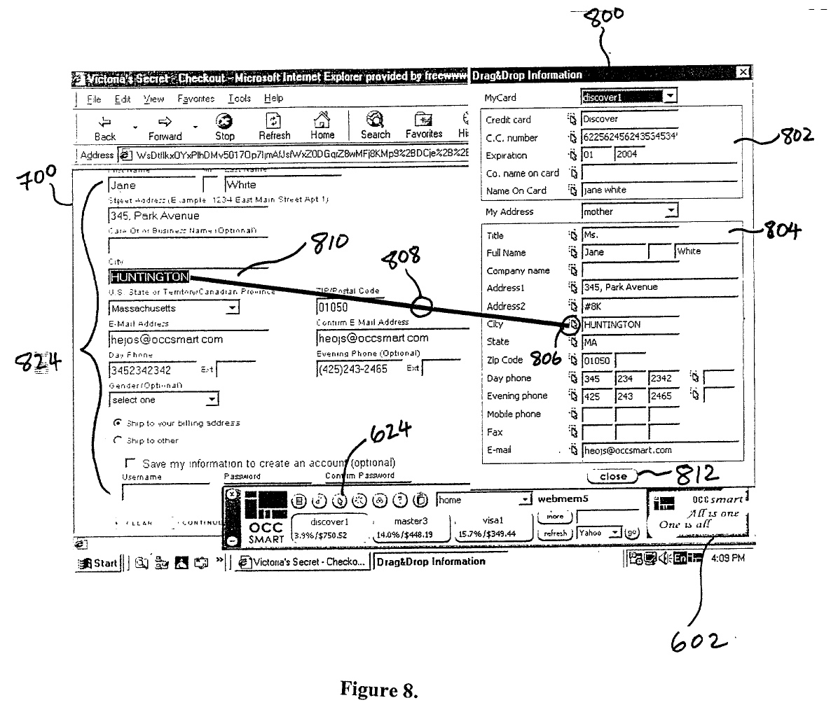

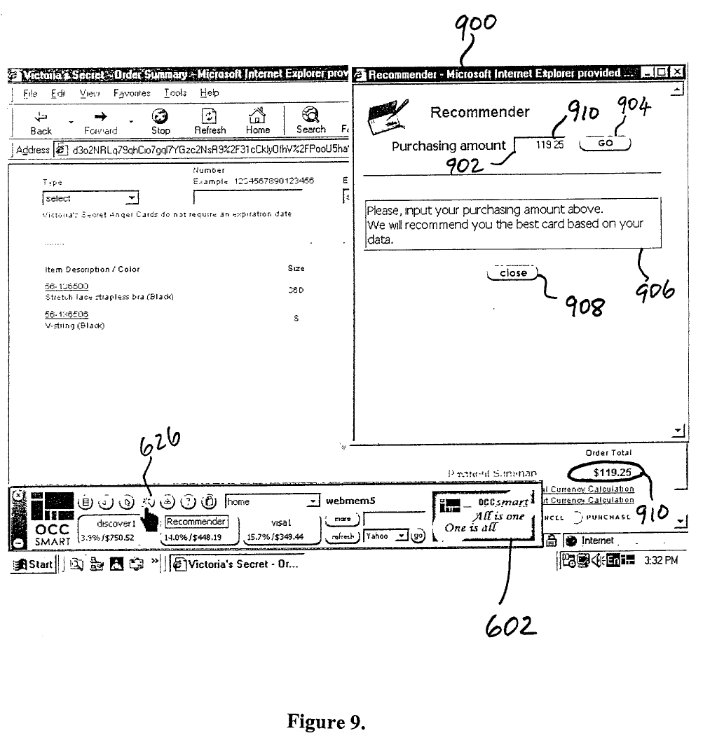

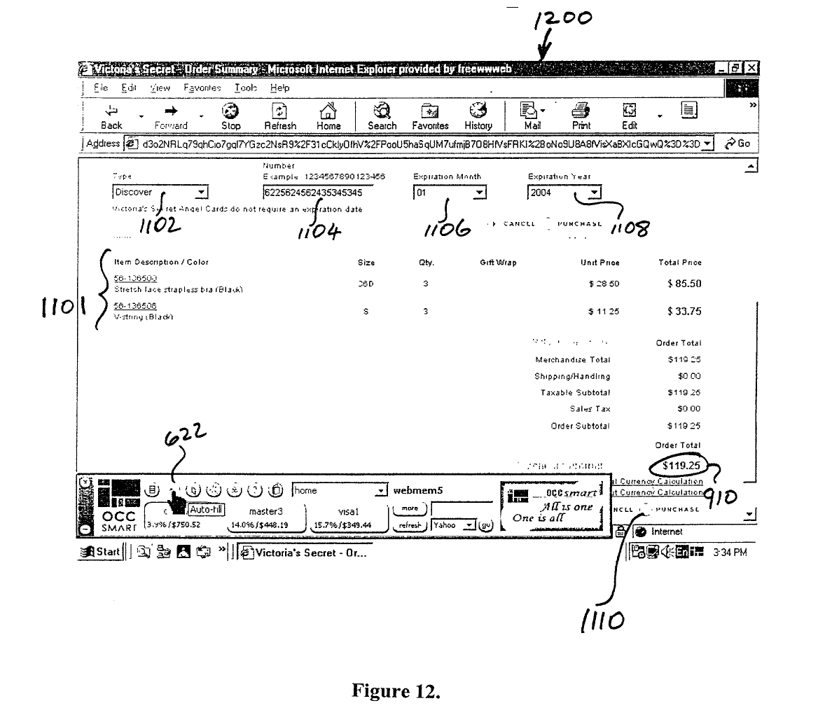

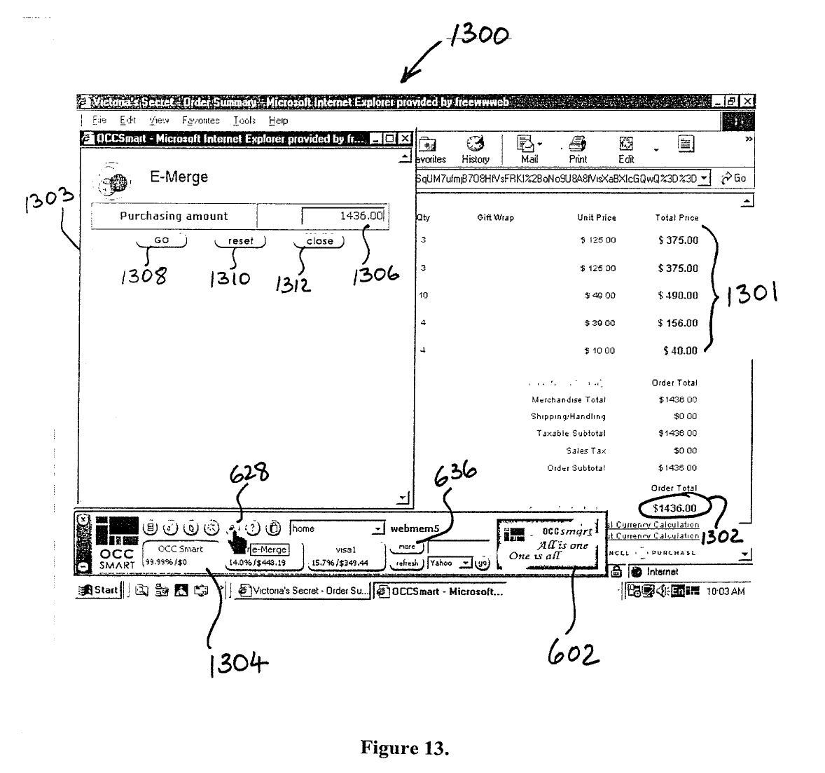

FIGS. 6 is a preferred embodiment of account management frame 602 for displaying a consumer's portfolio comprising credit card information, banking information and other financial information, and for facilitating the consumer to make efficient, economical an advantageous payment for an e-commerce transaction at a consumer-selected shopping portal according to the present invention. Once consumer 102 logs on to the account management frame 602 via logon web frame 500 of FIG. 5, the account management frame 602 is preferably displayed on top of consumer's web browser as a top-most window until consumer closes the account management frame 602. On the account management frame 602, buttons 616 and 618 respectively are used to close the account management frame 602 and minimize the account management frame 602 onto taskbar 652 or the system tray 652(a). Exemplary selectable buttons 646, 648 and 650 represent credit card accounts, banking accounts and other financial accounts (e.g., accounts from which money can be electronically drawn) for consumer 102 that have been registered by the consumer with Registry Website 104. For each credit account, there are displayed on the account management frame 602: the type of credit, available balance and applicable interest rate (“APR”). Other interest rates may be displayed for each credit card account, such as: 1) interest rate for purchases; 2) interest rate for cash withdrawals; 3) overdraw interest rate, and the like. Additional credit card accounts, banking accounts and other financial accounts may be viewed and selected by clicking on a “more” button 636, which brings into view other pre-registered financial accounts. Displaying additional accounts with “more” button is preferably accomplished by displaying a web frame (i.e., a popup window) with account information for the additional accounts, or alternatively by sequentially revolving accounts (one-by-one) on the account management frame 602 by clicking the “more” button 636. Refresh button 638 refreshes account information currently displayed on account management frame 602 by acquiring information from Registry Website 104. Menu button 620 is a pull-down menu, which comprises the following menu options exemplary menu options: 1) add/change address (FIG. 20); 2) add/change credit/banking/financial account (FIG. 21); 3) add/change preferences (not shown); 4) change/login settings (not shown). Auto-fill button 622 may be used by consumer 102 to automatically fill in the address and credit information on checkout web page at a shopping portal (described herein below in greater detail with reference to FIGS. 7 and 12. Drag-and-drop button 624 is utilized by consumer 102 to fill in information on checkout web page at a shopping portal when auto-fill is unable to automatically fill in the required information (described herein below with reference to FIG. 8). Recommender button 626 recommends to the consumer 102 a specific consumer credit account to use for an e-commerce transaction to achieve a specific consumer goal, such as minimizing interest payments (described herein below with reference to FIG. 9-12). e-Merge button 628, merges consumer's registered credit card accounts, banking accounts and other financial accounts into a single “virtual” credit account for maximizing consumer's purchasing power (described herein below with reference to FIG. 13-17). Help button 630 displays help information to consumer 102 in a conventional way. Shop button 632 may be provided to provide access to a plurality of shopping portals. Consumer 102 may also conventionally query a particular search engine (e.g., Yahoo™, Excite™, AltaVista™, and the like) via drop-down list 642 based on one or more search terms entered into input field 640, by pressing the “go” button 644 on the account management frame 602.

Furthermore with regard to FIG. 6, to perform an e-commerce transaction, consumer 102 launches an instance of a conventional web browser such as Microsoft Internet Explorer™ or Netscape Navigator™ and opens a shopping portal by typing in a universal resource locator (“URL”). Alternatively, consumer 102 may use searching capabilities 640, 642, 644 described hereinabove with reference to FIG. 6 to generate a web page with hyperlinks to a variety of shopping portals, any one of which consumer 102 may click thereby opening an associated shopping portal. Thereafter, consumer 102 performs the shopping transaction in a conventional manner until the typical checkout and payment web page at which point consumer 102 must provide payment information and shipping information, and is facilitated to do so via the account management frame 602.

FIGS. 3 is an alternate embodiment of account management frame 300 for displaying a consumer's portfolio comprising credit card information, banking information and other financial information, and for facilitating the consumer to make efficient, economical an advantageous payment for an e-commerce transaction at a consumer-selected shopping portal according to the present invention. Consumer 102 logs onto account management frame 300 in the same manner as described hereinabove with reference to FIGS. 4 and 5. The account management frame 300 displays credit information 301, such as, the consumer's maximum available credit 302 for the plurality of credit card accounts 302(a) . . . 302(c), the available credit 304 and interest rate 306 for each of the plurality of credit card accounts initially ranked by interest rate, banking information 307, such as available balance on the consumer's checking account(s) 308 . . . 312 as well as other financial information (not shown in FIGS. 4 and 5). This additional information may reflect available balances or various consumer preferences for individual accounts, “affinity cards” which donate a small percentage of each charge to a school or non-profit organization, or credit cards which provide airline “frequent flyer” credits for charges. The information displayed may also include preferential interest rates, such as those available for balance transfers or the like. Upon launching of account management frame 300, Registry Website 104 verifies information 120 that will be displayed from the credit card issuing bank 112, consumer's bank 116 and the like, and updates the information 122 when changes in the information have occurred in the card accounts, banking accounts and other financial accounts and transmits this information to the account management frame 300. It should be noted that during the consumer's shopping session, the account management frame 300 stays resident and is preferably a top-most frame, i.e., remaining “always on top.” The account management frame 300 includes input field 314 into which consumer 102 can enter a purchase amount for a purchase that the consumer would like to make at a shopping portal. The entry of the purchase amount can also be accomplished automatically with an auto-scrape function that is invoked whenever a consumer invokes a “proceed to checkout” link.

Furthermore, account management frame 300 also includes exemplary push buttons “Rank,” 316 “Pay,” 318 “Previous,” 320 and “Registry Website” 322. When a purchase amount is entered into input field 314, either manually or automatically, the Rank button 316 is highlighted. Clicking the Rank 316 button with a pointing device (e.g., mouse), consumer 102 directs the account management frame 300 to establish a preferred priority (e.g., a listing) of credit card or other credit accounts by ranking the displayed plurality of credit accounts, e.g., 302(a)-302(c), according to selected consumer preferences as discussed above, or by credit and interest rate parameters for the entered purchase amount. Ranking credit accounts via “Rank” button 316 is functionally similar to the recommender feature 626 coupled with e-Merge feature 628 of the preferred embodiment of the account management frame 600 described with reference to FIG. 6. That is, if the purchase amount is within the available credit of at least one of the plurality of credit accounts, Registry Website 104 will display the preferred priority (e.g., listing) of the plurality of credit accounts, according to the consumers preferences, or according to selected financial criteria such as available balance or the lowest interest rate. However, if the entered dollar amount is outside the available credit of each of the plurality of credit accounts, but is within the consumer's maximum available credit for the plurality of credit card accounts coupled with available balance in banking accounts 308, 310, 312 and other financial accounts (not shown), Registry Website 104 will notify consumer 102 at step 132 (FIG. 1) that consumer 102 can authorize at step 134 (FIG. 1) merging of the foregoing accounts sufficient to cover the entered purchase amount, i.e., transferring balances from the foregoing accounts into a Registry Website “virtual” credit account to facilitate such a purchase amount. It should be noted that exemplary input web frames for accomplishing merging are described with reference to FIGS. 13-17. Upon receiving authorization from the consumer 102 for merging at step 134, the Registry Website 104 requests balance transfers at step 136 (FIG. 1) from the credit card issuing bank 112, consumer's bank 116 and other financial institutions (not shown in FIG. 1). At this point, Registry Website 104 verifies information 120 that will utilized for merging by polling the credit card issuing bank 112, consumer's banks and other financial institutions (not shown), and updates credit card information 122, banking information at step 126 and other financial information (not shown) if changes in available credit have occurred for any of foregoing financial accounts and transmitting this information to the account management frame 300. This step is performed to ensure that information used in the merging calculations is most recent and to avoid pitfalls, such as where a consumer 102, while logged onto the account management frame 300 makes a purchase or otherwise transfers funds from banking accounts externally to the Registry Website 104. Upon receipt of authorizations for credit card transfers at step 138 coupled with authorizations for banking transfers 126 and other financial transfers (not shown), Registry Website 104 updates the new balances at step 123 in one or more databases 105. Thereafter, Registry Website 104 generates a “virtual” credit and transmits the foregoing information to the account management frame 300, which displays a virtual credit number to consumer 102 at step 140 enabling the “Pay” button 318 for facilitating consumer 102 to click on “Pay” button 318 with a mouse to make a purchase at a shopping portal. Payment for the shopping transaction is further described with reference to FIGS. 7, 8, 12 and 16.

Further with reference to FIG. 3, upon making a selection to purchase at the merchants website 106, the consumer enters the order and preferred credit card number (or “virtual” credit number as described above) as indicated at step 142. The merchant website (e.g., e-commerce sever) then checks with the credit card processor 110 and provides the preferred credit card number and purchase amount as indicated at step 144. Credit card processor 110 checks whether the provided credit card number is in good standing, and then issues an authorized code or declines the transaction. The credit card processor will relay the desired preferred credit card number and purchase amount to the credit card issuing bank as indicated at 146 which places a hold on that account for the amount, pending capture of the transaction. Upon receiving the authorization at step 150, the merchant website 106 then issues an order confirmation to the consumer 102 at step 152. The merchant website 106 then sends an order for the merchandise to the fulfillment house 108 as indicated at step 154 and the fulfillment house 108 sends and order acceptance and acknowledgment back to the merchant website 106 as indicated as step 156. If shipment is not immediate, a separate order fulfillment date will be specified. Based on certain bank card association rules, which issue credit cards, such as Visa and MasterCard, the merchant is not allowed to capture a transaction until goods that were ordered by the consumer are shipped. Therefore, there may be a time lag between the authorization and the capture. Moreover, if the consumer cancels the transaction before it is captured by the merchant, a void is generated. The final step of e-commerce purchase is a settle transaction between the merchant and the credit card processor, wherein daily captures and credits that have accumulated at the merchant's Web server are then submitted as a batch to the credit card processor to finalize the many daily transactions and to transfer money to the merchant's bank account. Upon indication that the fulfillment house has initiated delivery of the goods to consumer 102 at step 158, the fulfillment house will advise the merchant 106 of the order fulfillment and the merchant website 106 will advise credit card processor 110 of the confirmation of the delivery of goods. Credit card processor 110 will then forward this information to the credit card issuing bank at step 146 and transfer funds to the merchants bank 114 as indicated at step 160, thus providing payment to the merchant website for the merchandise shipped by the fulfillment house at step 158.

FIG. 7 illustrates an exemplary illustration of a shopping portal address entry web page 700 and an auto-fill feature 622 of the account management frame 602 according to the present invention. Upon “checking out” during a shopping transaction, consumer 102 must fill in, among other things, the consumer's shipping address. At the address entry web page of a shopping portal, consumer 102 simply presses the auto-fill feature 622, and the account management frame 602 automatically fills in pre-registered address information for consumer 102 into proper address fields 624 on the web page 700. If the auto-fill feature 622 is not able to automatically fill in consumer's address information, consumer 102 is notified via popup web frame (not shown) that automatic fill-in failed and consumer may use a drag-and-drop feature (described herein below with reference to FIG. 8) or manually type in address information to fill appropriate address fields 624 on address entry web page 700.

FIG. 8 illustrates filling address information on a shopping portal address entry web page 700 of FIG. 7 utilizing a drag-and-drop feature 624 of the account management frame 602 according to the present invention. Once consumer 102 is notified by the account management frame 602 that auto-fill feature 622 is unable to automatically fill in address information on a shopping portal address entry web page 700, consumer may use the drag-and-drop feature 624 to drag-and-drop address information on the address entry web page 700. Upon clicking drag-and drop feature 624, the account management frame 602 displays a drag-and-drop web frame 800, which contains credit information 802 and address information 804. As an example, a consumer wishing to fill-in “City” field 810 of address fields 824 on the web page 700, may click corresponding “City” field 806 on the drag-and drop web frame 800 and then drag 808 that information to field 810, thereby automatically filling in “City” field 810 on web page 700. Other fields of address fields 824 of web page 700 are filled in the same manner by the consumer 102. Upon completely filling required address information on web page 700, consumer 102 clicks the “Close” button 812 to exit the drag-and-drop feature 624.

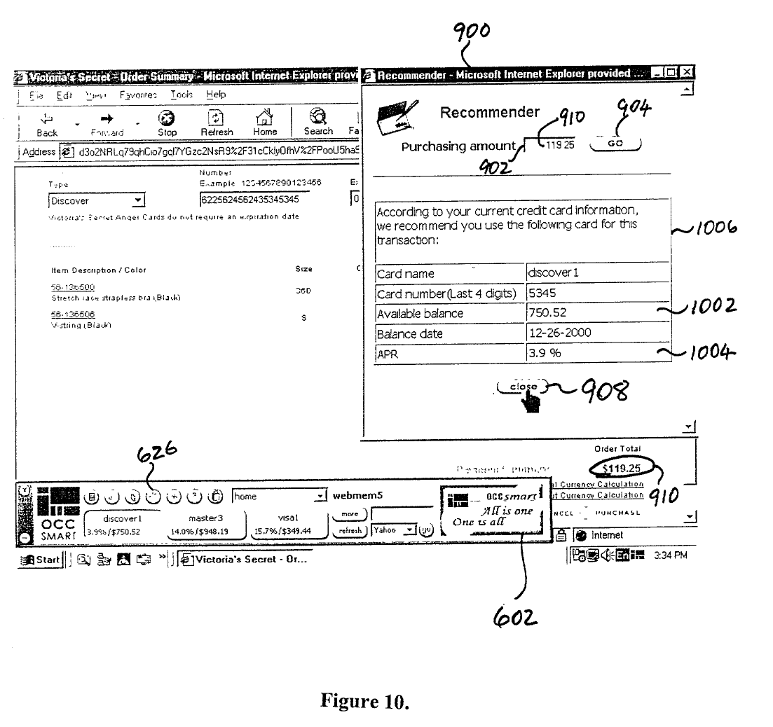

FIGS. 9 and 10 illustrate a recommender feature 626 of the account management frame 602 according to the present invention. At checkout or during any other point of a shopping transaction at a shopping portal, the consumer 102 may want to inquire as to which credit account is preferred to use for a given purchase amount 910. To have account management frame 602 recommend a credit account, consumer 102 clicks on the recommender feature 626, which displays an input web frame 900. Typewritten text 906 of web frame 900 explains the recommend feature 626 to consumer 102. At input field 902 of web frame 900, the consumer 102 enters a purchase amount 910, or the purchase amount is automatically entered via an auto-scrape or auto-complete function. The consumer then clicks the “Go” button 904 to continue with the recommend feature 626 or clicks the “Close” button 908 to exit the recommend feature 626. In FIG. 10, web frame 900 displays the preferred credit account to use for the purchase amount 910 based on available balance 1002, lowest interest rate 1004, or one of the other predefined criteria discussed above which reflect a consumer preference. It should be noted that if purchase amount 910 exceeds available balance of any registered credit card, web frame may direct the user via a popup web frame to use the e-Merge feature of account management frame 602 (described hereinafter in greater detail with reference to FIGS. 13-17).

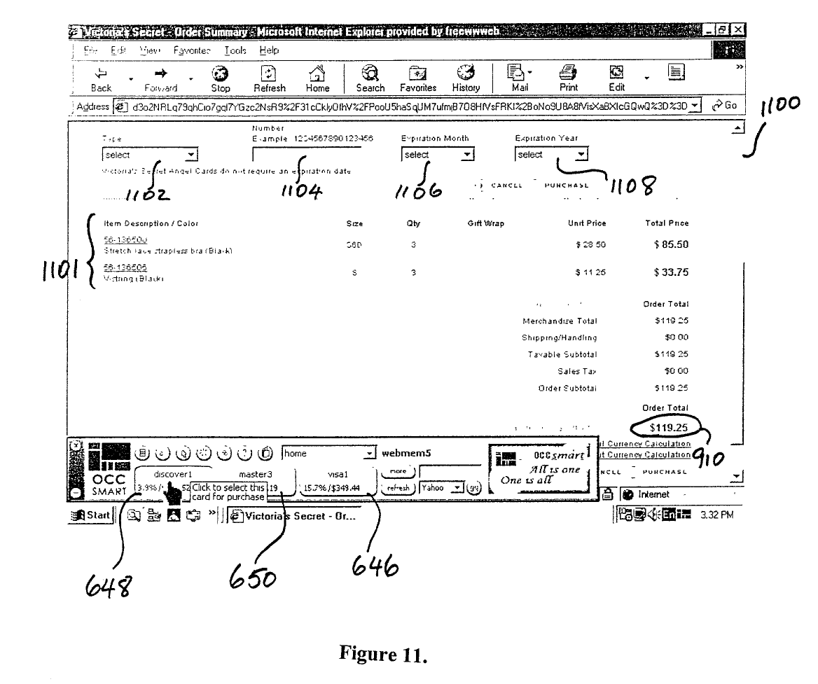

FIGS. 11 and 12 illustrate a consumer making a credit card payment at a shopping portal payment entry web page according to the present invention. For a particular purchasing transaction, at checkout, consumer 102 must fill in necessary credit card information 1102, 1104, 1106 and 1108 into payment entry web page 1100 to purchase one or more items of interest 1101 at the shopping portal. According to the present invention, after ascertaining total purchase amount due 910 and preferably using the recommender feature described hereinabove with reference to FIGS. 9 and 10 to recommend a credit card account to use for the purchase amount due, consumer 102 preferably selects credit account recommended 648 or any other account registered 646, 650 with Registry Website 104 to make payment. On the payment entry web page 1100 credit card fields 1102, 1104, 1106 and 1108 are automatically filled in by consumer 102 by utilizing auto-fill feature 622, as described hereinabove with reference to address auto-fill of FIG. 6. Alternatively, consumer may use the drag-and-drop feature 624 described herein above with reference to FIG. 8 to fill in appropriate credit information. Once the credit information is filled in either automatically via auto-fill feature or manually via the drag-and-drop feature, consumer 102 purchases the one or more items 1101 by clicking purchase button 1110, thereby completing the e-commerce purchase according to the present invention.

FIGS. 13-17 illustrate an e-Merge feature of the account management frame 602 according to the present invention. For a given e-commerce transaction, e-Merge feature 628 facilitates the consumer 102 to maximize consumer's purchasing power by merging credit accounts, banking accounts and other financial accounts into a “virtual” credit account with sufficient funds to make an e-commerce purchase. FIG. 13 illustrates a purchase web page 1300 listing one or more items of interest 1301 selected by consumer 102 for purchase, and a total purchase amount to be paid 1302. Upon ascertaining that none of the registered accounts (eg., credit account, banking account, and the like) can alone cover the purchase amount 1302, consumer 102 is enabled via e-Merge feature 628 to maximize consumer's purchasing power by merging one or more of a plurality of accounts registered with Registry Website 104 into a “virtual” credit account 1304 with sufficient funds to make the purchase. Consumer 102 may ascertain the available balances of the credit cards and other consumer credit accounts by using “More” button 636 to scroll through all accounts registered with Registry Website 104. Upon clicking on e-Merge feature 628, the account management frame 602 pops up an e-Merge web frame 1303 into which consumer 102 enters purchase amount 1306 corresponding to the purchase amount 1302 on purchase web page 1300. The “go” button 1308 facilitates consumer 102 to continue with e-Merge, while the “reset” button 1310 resets the purchase amount 1306 and the “close” button 1312 exits the e-Merge feature.

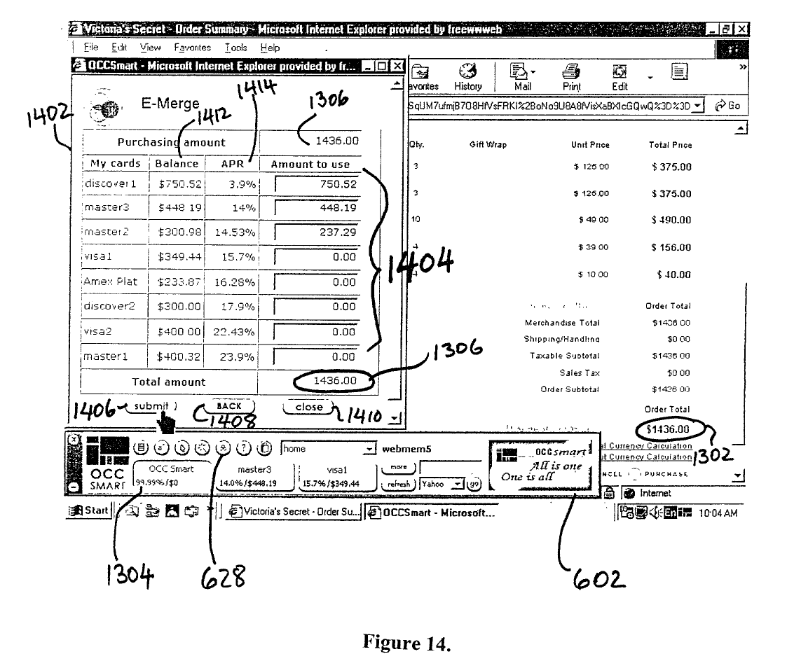

FIG. 14 illustrates an e-Merge web frame 1402 of the e-Merge feature 628 that is displayed to consumer 102 upon clicking “go” button 1308 described with reference to FIG. 13. The e-Merge web frame 1402 lists one or more accounts (e.g., credit, banking and other financial accounts) registered with Registry Website 104 by consumer 102 based on applicable rate of interest (“APR”) 1414, if any, and by available balance 1412. The e-Merge web frame 1402 facilitates consumer 102 to selectively adjust the exact dollar amount from each individual account to be combined or merged to equal the purchase amount 1306 (corresponding to purchase amount 1302) and input that information into an associated input field 1404. It is to be noted that consumer 102 may merge available balances of any of the foregoing accounts, such as choosing to merge available balances of bank accounts and financial accounts while choosing to exclude merging any credit card available balances. Upon finalizing adjustments to the dollar amounts 1404 of individual accounts to equal the purchase amount 1306, “submit” button is activated and maybe clicked by consumer 102, so that the account management frame 602 may merge dollar amounts 1404 into the “virtual” credit account 1304. The “back” button 1408 closes the current e-Merge web frame 1402 and pops up e-Merge web frame 1303 of FIG. 13, while the “close button” 410 exist the e-Merge feature 628.

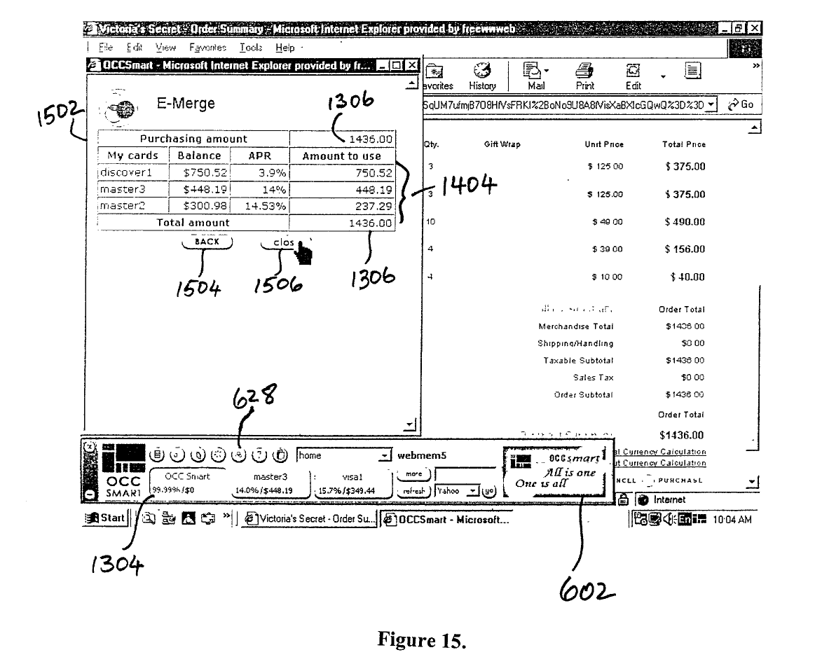

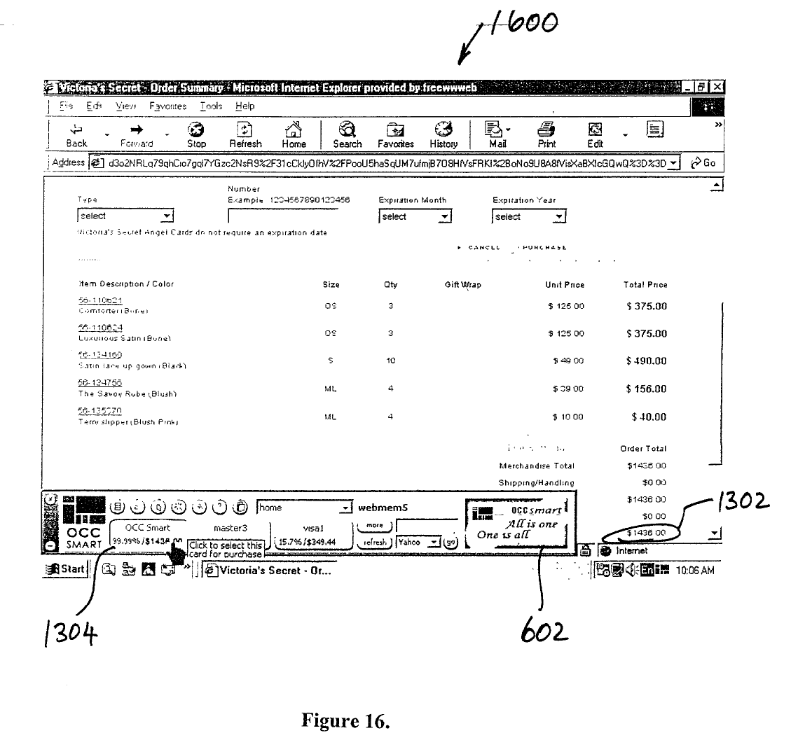

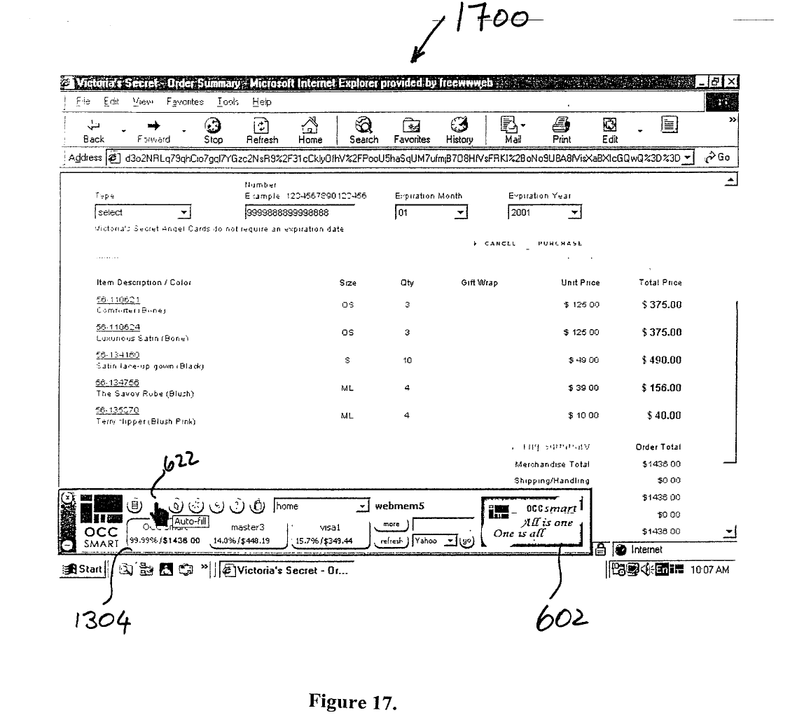

FIG. 15 illustrates an e-Merge web frame 1502 of the e-Merge feature 628 that is displayed to consumer 102 upon clicking “submit” button 1406 described with reference to FIG. 14. The e-Merge web frame 1502 illustratively displays to consumer 102 only the selected accounts and adjusted dollar amounts 1404, which are used to fund the purchase amount 1306. The “back” button 1504 may be clicked by consumer 102 to return back to e-Merge web frame 1402 for selectively making adjustments to dollar amounts 1404 of individual accounts to equal purchase amount 1306. The “close” button 1506 closes e-Merge web frame 1502, at which point the account management frame 602 funds the “virtual” credit account 1304 to be used as payment for purchase amount 1302, as particularly depicted in FIG. 16. FIG. 16 illustrates the merged amount 1306 on “virtual” credit account 1304 and the consumer 102 selecting the virtual credit account as payment for purchase amount 1302. FIG. 17 further illustrates consumer 102 utilizing the auto-fill feature 622 to fill virtual credit account 1304 information into appropriate input fields on web page 1700 in the same manner as described hereinabove with reference to FIG. 12.

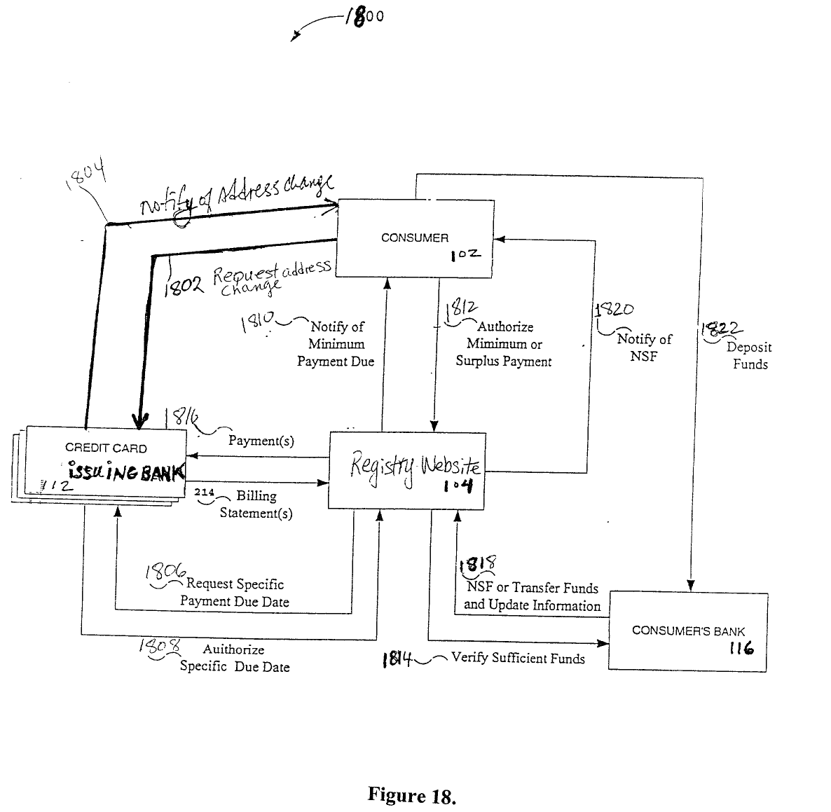

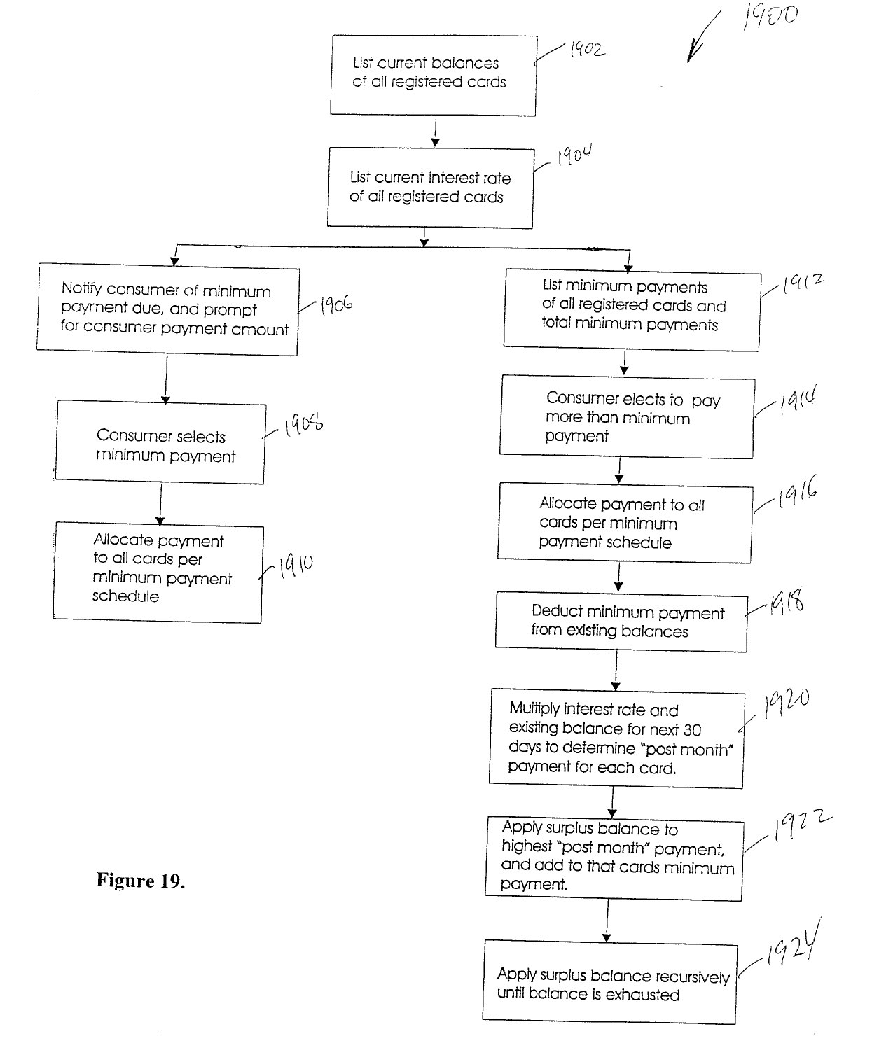

FIG. 18 is an exemplary block diagram 1800 of a system for making payment to a plurality of consumer's credit card accounts, while minimizing interest payments. Registry Website 104 facilitates the consumer in making and balancing payments to a plurality of consumer's credit card or credit accounts, while minimizing interest payments, or invoking other selection criteria, which is illustrated in greater with regard to FIG. 19. A consumer may select from several preferences as discussed previously, but may also choose a financial criteria, such as lowest possible interest payments, or closing out a particular account as the primary criteria. As depicted in FIG. 18, consumer 102 requests an address change at step 1802 for consumer's plurality of credit card accounts issued by credit card issuing banks 112, or other banks or financial institutions registered with Registry Website 104. It should be noted that the address change may be requested by Registry Website 104 as an agent on behalf of consumer 104. The address change requested is from the consumer's address to that of the Registry Website 104. Upon modification of the address, credit card issuing banks 112 and other financial institutions will send notifications 1804 to consumer 102. The address provided to the credit card issuing banks 112 or other institutions will be preferably an electronic address for the Registry Website 104 or alternatively the postal address for Registry Website 104, depending upon whether credit card issuing banks or institutions 112 generate electronic billing statements. At the close of each monthly billing cycle, each of the credit card issuing banks 112 or other institutions will issue a billing statement directly to the Registry Website 104 in either electronic form or standard form. The billing statements are then used to update the consumer's records as previously described with respect to FIG. 1.

Further with reference to FIG. 18, inasmuch as the various credit card issuing banks 112 or other financial institutions may have staggered payment due dates that are largely a function of the individual bank's credit processing systems, it is desired that the Registry Website 104 request a specific payment due date of each of the credit accounts at the issuing banks 112 as indicated at step 1806. The credit issuing banks 112 will then authorize a specific due date as step 1808. The setting of the specific payment due date enables Registry Website 104 to apply consumer-provided monthly payments in an efficient manner for minimizing overall interest payments. At step 1810, Registry Website 104 will notify the consumer 102 via e-mail of the minimum payment due. The minimum payment due is calculated by the Registry Website 104 by listing the minimum payment for a plurality of consumer's credit accounts registered with the Registry Website 104, summing up the minimum payments for determining the minimum payment balance to be remitted, and stating the date by which minimum payment must be made. Consumer 102 is then asked whether the consumer wants to pay an additional amount over and above the minimum payment due. At step 1812, consumer 102 may then authorize either the minimum payment due or a surplus payment to be remitted by Registry Website 104. The Registry Website 104 will then verify whether the consumer's bank 116 has sufficient funds for the payment authorized by consumer 102, as indicated at step 1814. If there are sufficient funds to cover the authorized payment, Registry Website 104 will then direct the consumer's banks 116 to tender payments to each of the plurality of registered credit card issuing banks 112 as indicated at step 1816 in accordance with the desired payment schedule authorized by consumer 102 at step 1812. If payment is successfully remitted by the consumer's bank 116, the bank will notify Registry Website 104 that funds have been transferred and necessary information will be updated at step 1818 in Registry Website one or more database 105 (described with reference to FIG. 1). However, if a not-sufficient funds (“NSF”) for a payment authorized by the consumer 102 is transmitted by the consumer's bank 116 at step 1818, Registry Website 104 advises consumer 102 of the NSF at step 1820, thus directing consumer 102 to deposit additional funds in the consumer's bank 116 as indicated at step 1822.

FIG. 19 is an exemplary flowchart 1900 for illustrating application of consumer-provided funds by Registry Website 104 in the payment process described with regard to FIG. 18, according to the present invention. At steps 1902, Registry Website 104 lists current balances of registered credit card and other credit accounts. At step 1904 Registry Website 104 lists current interest rate (“APR”) for the registered credit accounts. Alternately, preferential interest rates may be displayed. Steps 1906-1910 describe allocation of minimum payment to all registered credit card accounts, while steps 1912-1924 describe allocation of a surplus payment over and above the minimum payment for all credit accounts. At step 1906, Registry Website 104 notifies consumer 104 of a total minimum payment due for the registered credit accounts, and step 1908 consumer 102 elects to pay only the minimum payment due. At step 910, Registry Website 104 allocates minimum payment due to each credit account. At step 1912, Registry Website 1912 lists minimum payments due for registered accounts and the total minimum payment. At step 1914, consumer 102 elects to pay a surplus amount, which is greater than the total minimum amount due. At step 1916, Registry Website 104 first allocates a minimum payment amount to each registered credit account at step 1918. At step 1920, Registry Website 104 deducts minimum payment from total amount due on each account to establish a remaining balance. The remaining balance on each credit account is multiplied by a fractional interest rate (“APR”) applicable to each credit account for 30 days (i.e., one-month period) to establish a highest post-month payment for each credit account. The surplus amount provided by consumer 102 is then normally applied to the credit account with the highest post-month payment and is added to the minimum amount due on the that credit card account. At step 1924, any remaining surplus balance is recursively applied to the next credit account with the highest post-month payment, until the surplus balance is exhausted. It should be noted that the consumer may alter the above selection criteria as discussed previously to accomplish other consumer goals.

While the invention has been particularly shown and described with respect to preferred embodiments thereof, it will be understood by those skilled in the art that the foregoing and other changes in form and details may be made therein without departing from the spirit and scope of the invention, as particularly embodied in the appended claims.

1. A method for facilitating an electronic commerce (e-commerce) transaction by a consumer, said method comprising:
(a) acquiring a purchase amount for an e-commerce transaction between a consumer and an Internet shopping portal;
(b) querying each of a plurality of consumer accounts for associated financial information;
(c) evaluating said associated financial information obtained for each of said plurality of consumer accounts; and
(d) facilitating a selection of one or more accounts based on said evaluation step to enable the consumer to complete said e-commerce transaction.

2. The method according to claim 1, said method further comprising a step of pre-registering said plurality of consumer accounts at a registry website.

3. The method according to claim 1, wherein said plurality of consumer accounts includes one or more credit card accounts.

4. The method according to claim 1, wherein said plurality of consumer accounts includes one or more retail credit card accounts.

5. The method according to claim 1, wherein said plurality of consumer accounts includes one or more electronic bank accounts.

6. The method according to claim 1, wherein said plurality of consumer accounts includes one or more electronic financial accounts.

7. The method according to claim 1, said method further comprising a step of:
recommending an account to the consumer based on said evaluation step to thereby enable the consumer to complete said e-commerce transaction.

8. The method according to claim 2, said method further comprising the steps of:
creating a virtual account at said registry website that merges available balances of two or more of said plurality of consumer accounts to enable the consumer to fund said purchase amount for said e-commerce transaction.
funding said purchase amount with funds drawn from said two or more consumer accounts to complete said e-commerce transaction.

9. The method according to claim 8, said funding step further comprising a step of:
enabling the consumer to selectively adjust funds to be drawn from said two or more accounts to equal said purchase amount in accordance with consumer preferences.

10. The method according to claim 2, said method further comprising the steps of:
transmitting from said registry website a program to a consumer's computer and installing said program at the consumer's computer; and
instantiating said program by the consumer to display an account management frame to facilitate said e-commerce transaction by the consumer.

11. The method according to claim 2, said method further comprising the steps of:
transmitting from said registry website an account management frame for facilitating the consumer to complete said e-commerce transaction.

12. The method according to claim 10, said method further comprising a step of:
displaying via said account management frame financial information for said plurality of consumer's accounts, said financial information including available balance and applicable interest rate.

13. The method according to claim 11, said method further comprising a step of:
enabling the consumer to refresh said financial information displayed via said account management frame during a shopping transaction.

14. The method according to claim 1, said method further comprising a step of:
automatically providing financial information associated with a selected account to a shopping portal to enable the consumer to complete said e-commerce transaction.

15. The method according to claim 1, said method further comprising a step of:
displaying a web frame for said consumer, said web frame having financial information for said selected account; and
enabling the consumer to drag and drop said financial information to a shopping portal web page to complete said e-commerce transaction.

16. A method for facilitating an electronic commerce (e-commerce) transaction by a consumer, said method comprising:
(a) acquiring a purchase amount for an e-commerce transaction between a consumer and an Internet shopping portal;
(b) querying each of a plurality of consumer accounts for associated financial information;
(c) evaluating said associated financial information obtained for each of said plurality of consumer accounts; and
(d) recommending an account to the consumer based on said evaluation step to thereby enable the consumer to select said account to complete said e-commerce transaction.

17. A method for facilitating an electronic commerce (e-commerce) transaction by a consumer, said method comprising:
(a) acquiring a purchase amount for an e-commerce transaction between a consumer and an Internet shopping portal;
(b) querying each of a plurality of consumer accounts for associated financial information;
(c) evaluating said associated financial information obtained for each of said plurality of consumer accounts;
(d) creating a virtual account to merge available balances of two or more of said plurality of consumer accounts to enable the consumer to fund said purchase amount; and
(e) funding said purchase amount drawn from said two or more consumer accounts to complete said e-commerce transaction.

18. A system for facilitating electronic commerce (e-commerce) transactions by one or more consumers, said system comprising:
(a) a registry website server for registering a plurality of consumer accounts for each consumer and for transmitting financial information associated therewith to an account manager frame at a consumer's computer;
(b) a web browser at the consumer's computer for communicating to an e-commerce server to perform an e-commerce transaction for a purchase amount, said transaction being initiated by the consumer at said web browser;
(c) said account management frame querying said registry website server to obtain said financial information for each of said plurality of consumer accounts, evaluating said financial information and facilitating the selection of one or more consumer accounts based on said evaluation to enable the consumer to complete said e-commerce transaction.

19. The system according to claim 18, said registry website further comprising a means for pre-registering said plurality of consumer accounts.

20. The system according to claim 18, said account management frame further comprising a means for recommending an account for said purchase amount to the consumer based on said evaluation to thereby enable the consumer to complete said e-commerce transaction.

21. The system according to claim 18, said account management frame further comprising a means for enabling the consumer to create and fund a virtual account to satisfy said purchase amount at said registry website by merging available balances of two or more consumer's accounts to thereby enable the consumer to complete said e-commerce transaction.

22. The system according to claim 21, said account management frame further comprising a means for enabling the consumer to selectively adjust funds to be drawn from said two or more accounts to equal said purchase price in accordance with consumer preferences.

23. The system according to claim 21, said account management frame further comprising a means for displaying financial information for said plurality of consumer's accounts, said financial information including available balance and applicable interest rate.

24. The system according to claim 18, said account management web frame further comprising a means for enabling the consumer to refresh said financial information displayed via said account management frame.

25. A system for facilitating electronic commerce (e-commerce) transactions by one or more consumers, said system comprising:
(a) a registry website server for registering a plurality of consumer accounts for each consumer and for transmitting financial information associated therewith to an account manager frame at a consumer's computer, said consumer directing said account management frame to recommend one of consumer's accounts for a purchase price associated with an e-commerce transaction;
(b) a web browser at the consumer's computer for communicating to an e-commerce server to perform said e-commerce transaction, said transaction being initiated by the consumer at said web browser;
(c) said account management frame querying said registry website server to obtain said financial information for each of said plurality of consumer accounts, evaluating said financial information and recommending a consumer account based on said evaluation to enable the consumer to complete said e-commerce transaction.

26. A system for facilitating electronic commerce (e-commerce) transactions by one or more consumers, said system comprising:
(a) a registry website server for registering a plurality of consumer accounts for each consumer and for transmitting financial information associated therewith to an account manager frame at a consumer's computer, said consumer directing said account management frame to merge one or more of consumer's accounts for a purchase price associated with an e-commerce transaction;
(b) a web browser at the consumer's computer for communicating to an e-commerce server to perform an e-commerce transaction, said transaction being initiated by the consumer at said web browser;
(c) said account management frame acquiring said purchase amount for said e-commerce transaction from the consumer, querying said registry website server to obtain said financial information for each of said plurality of consumer accounts, evaluating said financial information and enabling the consumer to create and fund a virtual account at said registry website by merging available balances of two or more consumer's accounts to enable the consumer to complete said e-commerce transaction.
